(19) United States
(12) Patent Application Publication
(10) Pub. No.: US 2025/0135564 A1
(43) Pub. Date: May 1, 2025

(54) SAW DEVICE AND METHOD

(71) Applicant: Festool GmbH, Wendlingen (DE)

(72) Inventors: Florian RAUSCHER, Weilheim an der Teck (DE); Jörg LARCHÉ, Remshalden (DE); David Messer, Zell unter Aichelberg (DE); Severin JUST, Stuttgart (DE)

(21) Appl. No.: 18/835,306

(22) PCT Filed: Feb. 2, 2023
(86) PCT No.: PCT/EP2023/052565

§ 371 Date: Aug. 1, 2024

(30) Foreign Application Priority Data
Feb. 3, 2022 (DE) 10 2022 201 165.1

(51) Int. Cl. B23D 59/00; B23D 45/04; B23D 45/06

(52) U.S. Cl. CPC B23D 59/002; B23D 45/044; B23D 45/068

(57) ABSTRACT

A sawing device, in particular a circular saw bench or crosscut saw, including a workpiece support for supporting a workpiece, a saw blade, and an electrical actuator device for setting a saw blade position of the saw blade relative to the workpiece support. The electrical actuator device has a first electrical actuator which includes a first rotor and serves to set the saw blade position in a first degree of freedom, in particular a saw blade angle, and the sawing device is designed to detect a current saw blade position of the saw blade on the basis of a first rotor movement of the first rotor.

The invention relates to a saw device, in particular to a bench saw or mitre saw, comprising a workpiece rest for the rest of a workpiece, a saw blade, as well as an electrical actuator device for setting a saw blade position of the saw blade relative to the workpiece rest, wherein the electrical actuator device comprises a first electrical actuator which comprises a first rotor and serves for setting the saw blade position in a first degree of freedom, in particular in a saw blade angle.

WO2018065040A1 describes a mobile bench saw with an electrical actuator for displacing the saw blade position.

An object of the invention lies in providing an improved saw device.

The object is achieved by a saw device according to claim 1. The saw device is designed to detect a current saw blade position of the saw blade on the basis of a first rotor movement of the first rotor.

The detected saw blade position can be used for example by the saw device, in order to display the current saw blade position to the user and/or to bring the saw blade into a predefined saw blade position, for example amid the use of a position control or position closed-loop control on the basis of the detected saw blade position.

The first rotor blade movement is for example a step or revolution of the first rotor and is expediently detected in the course of the operation of the first electrical actuator, for example on the basis of a voltage and/or a current of the first electrical actuator. Due to the fact that the saw blade position is detected on the basis of the first rotor movement, it is expediently not necessary to provide an individual position sensor for the saw blade position.

Advantageous further developments are the subject-matter of the dependent claims.

The invention further relates to a method for the operation of the saw device, comprising the step: detecting the current saw blade position on the basis of the first rotor movement.

Further exemplary details as well as exemplary embodiments are explained hereinafter with reference to the figures. Herein are shown

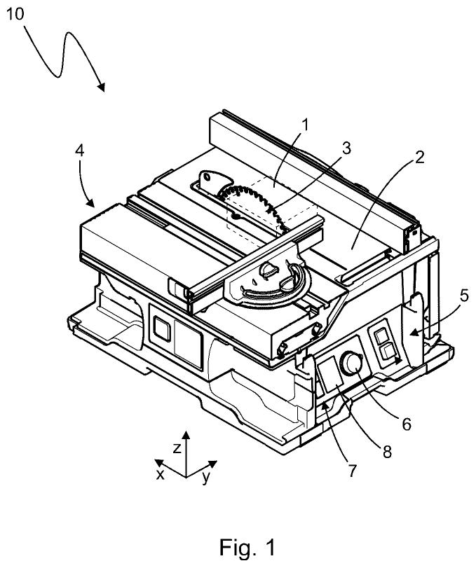

FIG. 1 a perspective representation of a saw device,

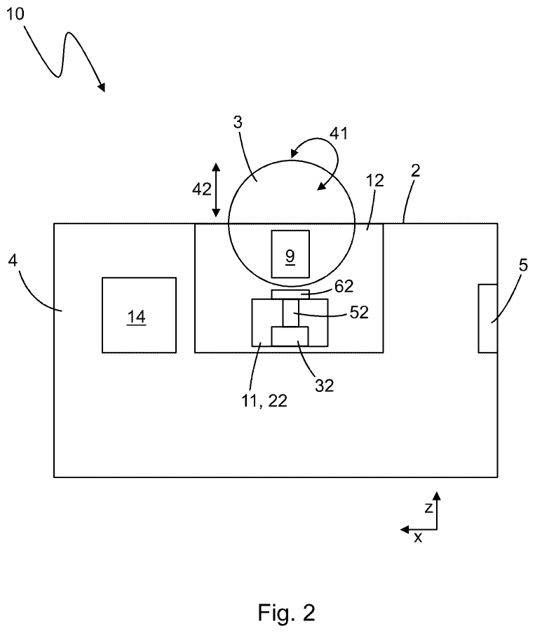

FIG. 2 a schematic lateral view of the saw device,

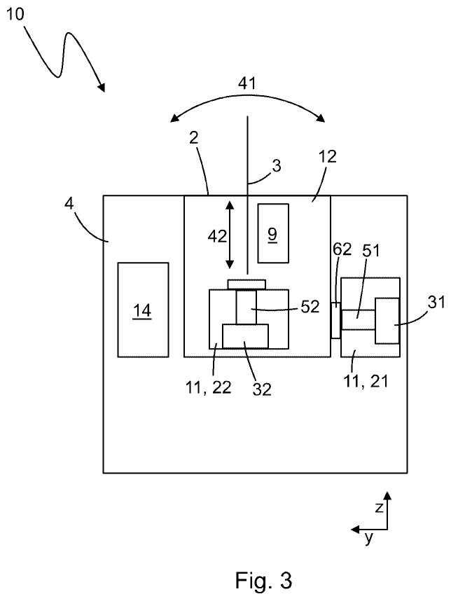

FIG. 3 a schematic front view of the saw device, and

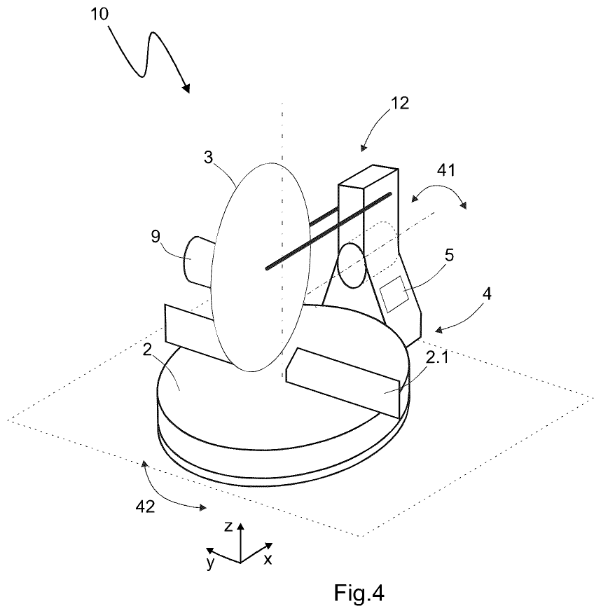

FIG. 4 a schematic representation of a saw device corresponding to an alternative embodiment.

The directions x-direction, y-direction and z-direction which are drawn in the figures and are aligned orthogonally to one another are referred to hereinafter in the following explanations. The x-direction and the y-direction are horizontal directions and the z-direction is a vertical direction.

FIG. 1 shows an exemplary design of a saw device 10. The saw device 10 is designed by way of example as a bench saw. Alternatively, the saw device 10 can also be designed differently, for example as a mitre saw. An exemplary embodiment of the saw device 10 as a mitre saw is shown in FIG. 4.

The saw device 10 in particular is designed as a semi-stationary saw device. A semi-stationary saw device is a saw device which for sawing a workpiece 1 is placed on a base surface in a stationary manner and which can be carried by a single user.

The saw device 10 comprises a workpiece rest 2 which in particular is designed as a workpiece rest surface. In a working position of the saw device 10, the workpiece rest 2 is aligned normally to the z-direction.

The saw device 10 comprises a saw blade 3. The saw blade 3 is aligned with its saw blade plane parallel to the x-direction. Expediently, the cutting direction of the saw blade 3 runs in the x-direction. The saw blade 3 expediently projects upwards out of the workpiece rest 2 from an opening present in the workpiece rest 2 and/or projects downwards into this.

The saw device 10 expediently comprises a support structure 4 which by way of example has a cuboid basic shape. The support structure 4 expediently provides the outer housing of the saw device 10. Preferably, the upper side of the support structure 4 provides the workpiece rest 2. In the working position, the saw device 10 with the lower side of the support device 4 stands on a base surface.

The saw device 10 expediently comprises an operating device 5. A user can operate the saw device 10 via the operating device 5. The operating device 5 by way of example is arranged on a peripheral side of the support structure 4. The operating device 5 comprises one or more operating elements which can be actuated by a user in order to operate the saw device 10. For example, the operating device comprises a rotary push button 6 and/or one or more buttons 7. Preferably, the operating device 5 further comprises a display unit 8.

FIG. 2 shows a schematic lateral view of the saw device 10 and FIG. 3 shows a schematic front view of the saw device 10.

The saw device 10 comprises an electrical saw blade drive unit 9 which by way of example comprises an electric motor which is also to be denoted as a drive electrical motor. The electrical saw blade drive unit 9 serves for bringing the saw blade 3 into a saw blade rotation movement in which the workpiece 1 can be sawn with the saw blade 3. The saw blade rotation movement in particular is effected about a rotation axis which is aligned perpendicularly to the saw blade plane.

The saw device 10 comprises an electrical actuator device 11 for setting a saw blade position of the saw blade 3 relative to the workpiece rest 2. The saw blade 3 can be positioned in its saw blade position relative to the workpiece rest 2, in particular in two degrees of freedom, by the electrical actuator device 11.

Preferably, the electrical actuator device 11 comprises a first actuator 21. The first actuator 21 comprises a first rotor 31. For example, the first actuator 21 comprises a first electric motor and the first rotor is part of the first electrical motor. The first actuator 21 serves for adjusting the saw blade position in a first degree of freedom 41, in particular in a saw blade angle. The first degree of freedom 41 by way of example is a rotational degree of freedom, in particular about a pivot axis which runs parallel to the cutting direction of the saw blade 3, in particular parallel to the x-direction. The first actuator 21 is designed to bring the saw blade 3 into a pivoting movement along the first degree of freedom 41. The first actuator 21 by way of example is designed as a spindle drive 21. Preferably, the first actuator 21 comprises a first movement element 61 which by way of a first rotation movement of the first rotor 31 is brought into a first linear movement. The first rotation movement by way of example is effected about a rotation axis which is directed in the y-direction. The first movement element 61 is coupled in movement to the saw blade 3 in a manner such that the pivoting movement of the saw blade 3 can be effected along the first degree of freedom 41 by way of the first linear movement of the first movement element 61. For example, the first actuator 21 comprises a first spindle 51 which by way of the first rotation movement of the first rotor 31 is brought into a first spindle rotation movement, by way of which the first linear movement of the first movement element 61 is effected. The first movement element 61 is designed for example as a spindle nut. Alternatively, the first movement element 61 can be designed as a spindle which by way of the first rotation movement of the first rotor 31 is brought into the first linear movement.

By way of example, the saw device 10 comprises a pivot arrangement 12 which by way of example comprises the saw blade 3, the saw blade drive unit 9 and expediently a second actuator 22. The pivoting arrangement 12 as a whole is pivotably mounted about a pivot axis which runs parallel to the x-direction. The pivoting arrangement 12 is coupled in movement to the first movement element 61, so that a pivoting movement of the pivoting arrangement 12 can be effected by the first linear movement of the first movement element 61, in order to thus move, in particular pivot the saw blade 3 along the first degree of freedom 41.

Preferably, the electrical actuator device 11 further comprises a second electrical actuator 22. The second actuator 22 comprises a second rotor 32. For example, the second actuator 22 comprises a second electrical motor, and the second rotor 32 is part of the second electrical motor. The second actuator 22 serves for adjusting the saw blade position in a second degree of freedom 42, for example in a saw blade height or a second angle. The second actuator 22 is designed to bring the saw blade 3 (in particular together with the saw blade drive unit 9) into a movement along the second degree of freedom 42. The second degree of freedom by way of example is a linear degree of freedom, in particular in a y-z plane. Preferably, the direction of the second degree of freedom 42 corresponds to the saw blade angle which can be set via the first degree of freedom 41. For example, given a vertical alignment of the saw blade plane, the direction of the second degree of freedom is the z-direction. In an alternative design (represented in FIG. 4), the second degree of freedom 42 by way of example is a rotation degree of freedom, in particular about the z-axis. The second actuator 22 by way of example is designed as a second spindle drive. Preferably, the second actuator 22 comprises a second movement element 62 which by way of a second rotation movement of the second rotor 32 is brought into a second linear movement. The second movement element 62 is coupled in movement to the saw blade 3 in a manner such that the movement of the saw blade 3 along the second degree of freedom 42 can be effected by the second linear movement of the second movement element 62. For example, the second actuator 22 comprises a second spindle 52 which by way of the second rotation movement of the second rotor 32 is brought into a second spindle rotation movement, by way of which the second linear movement of the second movement element 62 is effected. The second movement element 62 is designed for example as a spindle nut. Alternatively, the second movement element 62 can be designed as a spindle which can be brought into the second linear movement by way of the second rotation movement of the second rotor 32.

Preferably, the saw device 10 further comprises a control unit 14 which comprises for example a microcontroller. The control unit 14 is communicatively connected to the operating device 5. The control unit 14 is designed to receive an operating signal from the operating device 5, said operating signal expediently representing an operation of the operation device 5 which is carried out by the user. The control unit 14 is communicatively connected to the saw blade drive unit 9 and in particular is designed to control the saw blade drive unit 9 with a drive unit control signal, in particular according to the operating signal, in order to effect the bringing of the saw blade 3 into the saw blade rotation movement. The control unit 14 is communicatively connected to the first actuator 21. The control unit 21 in particular is designed to control the first actuator 21 with the first drive actuation signal, in particular according to the operating signal, in order to effect the bringing of the saw blade 3 into a first displacement movement along the first degree of freedom 41. The control unit 14 is communicatively connected to the second actuator 22. The control unit 14 in particular is designed to control the second actuator 22 with a second drive actuation signal, in particular according to the operating signal, in order to effect the bringing of the saw blade 3 into a second displacement movement along the second degree of freedom 42.

Preferably, the saw device 10, in particular the control unit 14 is designed to detect a current saw blade position of the saw blade 3 on the basis of a first rotor movement of the first rotor 31. The first rotor movement by way of example is the rotation movement of the first rotor 31, via which the first movement element 61 can be brought into the first linear movement.

The saw device 10, in particular the control unit 14 is preferably designed to detect first rotor movement information which represents the first rotor movement, and to compute the current saw blade position of the saw blade 3 on the basis of the rotor movement information

Preferably, the saw device 10, in particular the control unit 14 is designed to detect a number of revolutions (in particular of the first rotor 31) and/or steps (in particular of the first rotor 31), as the first rotor movement, in particular as the first rotor movement information. Preferably, the first electric motor is designed as a first stepper motor and the detected rotor movement is a number of steps, in particular micro-steps of the first rotor 31 of the first stepper motor. By way of example, the saw device 10 is designed to detect the first rotor movement in the course of an operation of the first electrical actuator 21, for example on the basis of a voltage and/or current of the first electrical actuator 21.

The saw device 10 is preferably designed to detect the current saw blade position without a position sensor, on the basis of the first rotor movement. In particular, the saw device 10 is designed to detect the current saw blade position without the use of a position sensor. For example, the saw device 10 has no position sensor for the detection of the current saw blade position, in particular has no position sensor for a direct detection of the current saw blade position.

The saw device 10, in particular the control unit 14 is preferably designed to compute a current first saw blade position value on the basis of the detected rotor movement. The first saw blade position value describes the saw blade position with respect to the first degree of freedom 41. The first saw blade position value is for example an angle of the saw blade 3, in particular relative to an x-z plane-thus in particular relative to a vertical plane which is aligned parallel to the cutting direction of the saw blade.

Preferably, the saw device 10, in particular the control unit 14 is designed to compute the current first saw blade position value on the basis of a preceding first saw blade position value and on the basis of the first rotor movement. The preceding first saw blade position value represents the saw blade position before the first rotor movement. For example, the control unit 14 converts the first rotor movement into an angle change of the saw blade 3, and adds the angle change to the preceding first saw blade position value, in order to obtain the current first saw blade position value.

Expediently, the saw device 10, in particular the control unit 14 is designed to incrementally determine the saw blade position, in particular on the basis of the first rotor movement.

Preferably, the saw device 10, in particular the control unit 14 is designed to detect the current saw blade position on the basis of the first rotor movement and on the basis of a second rotor movement of the second rotor 32. The second rotor movement is the rotation movement of the second rotor 32, via which the second movement element 62 is brought into the second linear movement.

Preferably, the saw device 10, in particular the control unit 14 is designed to determine the current first saw blade position value and a current second saw blade position value as the current saw blade position. The second saw blade position value describes the saw blade position with respect to the second degree of freedom 42. The second saw blade position value is for example a height of the saw blade 3, for example of an upper edge of the saw blade 3, in particular relative to the workpiece rest 2 (preferably with respect to a vertical alignment of the saw blade plane). Expediently, the second saw blade position value is a cutting depth of the saw blade 3. In an alternative design, the second saw blade position value is for example a second angle of the saw blade 3, for example about the z-axis or in a plane of the workpiece rest 2. Expediently, the second saw blade position value describes a second cutting angle of the saw blade 3.

Preferably, the saw device 10, in particular the control unit 14 is designed to detect second rotor movement information which represents the second rotor movement, and to compute the current saw blade position, in particular the current second saw blade position value on the basis of the second rotor movement information.

Preferably, the saw device 10, in particular the control unit 14 is designed to detect a number of revolutions (in particular of the second rotor 32) and/or steps (in particular of the second rotor 32) as the second rotor movement, in particular as the second rotor movement information. Preferably, the second electrical motor is designed as a second stepper motor, and the detected rotor movement is a number of steps, in particular micro-steps, of the second rotor 32 of the second stepper motor. By way of example, the saw device 10 is designed to detect the second rotor movement in the course of an operation of the second electrical actuator 22, for example on the basis of a voltage and/or a current of the first electrical actuator 22.

Preferably, the saw device 10, in particular the control unit 14 is designed to compute the current second saw blade position value on the basis of the detected second rotor movement. The second saw blade position value is for example the height of the saw blade 3 (preferably with respect to a vertical alignment of the saw blade plane).

Preferably, the saw device 10, in particular the control unit 14 is designed to compute the current second saw blade position value on the basis of a preceding second saw blade position value and on the basis of the second rotor movement. The preceding second saw blade position value represents the saw blade position before the second rotor movement. For example, the control unit 14 converts the second rotor movement into a height change of the saw blade 3 and adds the height change to the preceding second saw blade position value, in order to obtain the current second saw blade position value.

Expediently, the saw device 10, in particular the control unit 14 is designed to incrementally determine the saw blade position, in particular on the basis of the first rotor movement and/or the second rotor movement.

The saw device 10, preferably the control unit 14 is expediently designed to store the current saw blade position, in particular the current first saw blade position value and/or the current second saw blade position value, in particular in a memory of the control unit 14. The saw device 10 is expediently designed to display the current first saw blade position, in particular the current first saw blade position value and/or the current second saw blade position value on the display unit 8.

According to an alternative design, the saw device 10 is designed as a mitre saw. In this case, the first degree of freedom is expediently a cutting angle and/or the second degree of freedom is a mitre angle.

The saw device 10 is preferably designed to execute a calibration run of the saw blade 3 amid the use of the actuator device 11, in order to obtain calibration information and/or in order to carry out a position comparison of the detected saw blade position with an actual saw blade position.

Given the calibration run, the saw blade 3 is expediently brought into one or two end positions with regard to the first degree of freedom 41—thus in particular into a maximal saw blade angle and/or into a minimal saw blade angle, and/or is brought into one or two end positions with regard to the second degree of freedom 42—thus in particular into a maximal saw blade height or a maximal mitre angle and/or a minimal saw blade height or a minimal mitre angle. Expediently, the control unit 14 is designed to control the first actuator 21 and the second actuator, in order to effect the calibration run of the saw blade 3.

The end positions which relate to the first degree of freedom 41 in particular can be denoted as angle end positions and/or the end positions which relate to the second degree of freedom 42 in particular can be denoted as second end positions or as height end positions.

Each end position is expediently defined by a respective end stop.

Preferably, the saw device 10 is designed to detect the calibration information of the basis of the first and/or the second rotor movement and/or on the basis of in particular externally fed measurement information which for example describes the position of the saw blade 3 in one or each end position of the first and/or second degree of freedom 41, 42 and/or in a first and/or second zero position.

Preferably, the calibration information comprises displacement region information. The displacement region information expediently describes a displacement region, in particular an extension of the displacement region, of the saw blade 3 between two end positions of the saw blade 3.

In particular, the displacement region information comprises a first displacement region value which relates to the first degree of freedom 41 and/or a second displacement region value which relates to the second degree of freedom 42. The first displacement region value describes for example the extension of the first displacement region of the saw blade 3 with respect to the first degree of freedom 41. The extension of the first displacement region by way of example is an angular difference between a (with respect to the first degree of freedom 41) first and second end position of the saw blade 3—thus between the minimal saw blade angle and the maximal saw blade angle.

The second displacement region value describes for example the extension of the second displacement region of the saw blade 3 with respect to the second degree of freedom 42. The extension of the second displacement region by way of example is a height difference or mitre angle difference between a (with respect to the second degree of freedom 42) first and second end position of the saw blade 3—thus between the minimal saw blade height and the maximal saw blade height or between the minimal mitre angle and the maximum mitre angle.

Expediently, the saw device 10, in particular the control unit 14 computes the displacement region information on the basis of the first rotor movement and/or of the second rotor movement which are carried out during the calibration run.

Preferably, the calibration information comprises end position information which describes one or two end positions of the saw blade 3. For example, the end position information comprises a first end position value which relates to the first degree of freedom 41 and which describes a first end position with respect to the first degree of freedom 41, for example a minimal saw blade angle, and/or a second end position value which relates to the first degree of freedom 41 and which describes a second end position with respect to the first degree of freedom 41, for example a maximal saw blade angle.

For example, the end position information comprises a first end position value which relates to the second degree of freedom 42 and which describes a first end position with respect to the second degree of freedom 42, for example a minimal saw blade height or a minimal mitre angle, and/or a second end position value which relates to a second degree of freedom 42 and describes a second end position with respect to the second degree of freedom 42, for example a maximal saw blade height or a maximal mitre angle.

Optionally, each end position value is detected by way of an external sensor arrangement when the saw blade 3 is situated in the respective end position, and externally fed to the saw device 10, in particular the control unit 14.

Preferably, the calibration information comprises zero position information which describes one or two zero positions of the saw blade 3. For example, the zero position information comprises a first zero opposition value which relates to the first degree of freedom 41. The first zero position value describes a first zero position of the saw blade 3. Expediently, in the first zero position the saw blade 3 is aligned vertically with its saw blade plane. The saw blade angle is expediently equal to zero in the first zero position. The first zero position can also be denoted as an angle zero position.

For example, the calibration information comprises a second zero position value which relates to a second degree of freedom 42. The second zero position value describes a second zero position of the saw blade 3. Expediently, the saw blade 3 in the second zero position is positioned with its upper edge at the same height as the workpiece rest 2. The saw blade height is expediently equal to zero in the second zero position. The second zero position can also be denoted as a height zero position. In an alternative embodiment, the saw blade 3 in the second zero position is aligned perpendicularly to a workpiece stop, in particular to a rail 2.1, which is arranged upon or on the workpiece rest 2.

The saw device 10 is preferably designed to carry out a calibration run of the saw blade 3 amid the use of the actuator device 11, in order to carry out a position comparison of the detected saw blade position with an actual saw blade position. For example, the saw device 10 in the course of the calibration run brings the saw blade 3 into an end position with respect to the first degree of freedom 41 and in this end position sets the current first saw blade position value equal to an end position value which is assigned to this end position and which relates to the first degree of freedom 41, for example equal to the first end position value or the second end position value. The end position value, to which the current first saw blade position value is set, is expediently stored in the control unit 14 and/or has been determined in the course of a preceding calibration run.

For example, in the course of the calibration run, the saw device 10 brings the saw blade 3 into an end position with respect to the second degree of freedom 42 and in this end position sets the current second saw blade position value equal to an end position value which is assigned to this end position and which relates to the second degree of freedom 42, for example to the first end position value or to the second end position value. The end position value, to which the current second saw blade position value is set, is expediently stored in the control unit 14 and/or has been determined in the course of a prior calibration run.

The saw device 10, in particular the control unit 14 is preferably designed to detect the current saw blade position-in particular the first saw blade position value and/or the second saw blade position value-whilst taking into account the calibration information. In particular, the saw device 10, preferably the control unit 14 is designed, on detecting the current saw blade position, to take into account the zero position information, in order to compute the current saw blade position-this in particular the first current saw blade position value and/or the second current saw blade position value-with respect to the first zero position and/or the second zero position.

Preferably, the saw device 10, in particular the control unit 14 is designed, in the course of a calibration examination, to examine whether the calibration run is necessary and, if the calibration examination results in the calibration run being necessary, to carry out the calibration run and/or output a calibration message. Preferably, the saw device 10 outputs the calibration message on the display unit 8. The calibration message in particular is a request to the user to activate the calibration run, for example by way of a user input via the operating device 5.

Preferably, the calibration run can be activated manually via a user input, in particular via the operating device 5. Optionally, the saw device 10 can be designed to activate the calibration run automatically, in particular on the basis of the calibration examination.

Expediently, the saw device 10, in particular the control unit 14 is designed, given the calibration examination, to examine whether a drive error, for example a locking and/or a slipping of the actuator device 11 is given or was given since the last calibration examination.

A drive error in particular is present when a step loss, for example an actual step loss or an assumed step loss, of a stepper motor—in particular of the first and/or second stepper motor—of the actuator device 11 is present. A step loss is caused for example by way of a locking of the mechanics of the actuator device 11, so that several micro-steps of the stepper motor—in particular of the first stepper motor and/or of the second steppe rotor—are carried out without these being detected as the (first and/or second) rotor movement. For example, one or more micro-steps can be lost—thus not be detected as the (first and/or second) rotor movement—when the motor briefly slips. The step loss can have the effect of the current saw blade position which is detected on the basis of the first and/or second rotor movement not corresponding to the actual saw blade position.

The saw device 10 is preferably designed, as a response to the drive error, to carry out the calibration run and/or to output the calibration message.

Optionally, the saw device 10 is designed, as a response to a drive error which occurs directly at the beginning (in particular in a starting ramp of the first and/or second stepper motor) of a displacement movement of the saw blade 3, to carry out the calibration run and/or to output the calibration message.

Optionally, the saw device 10 is designed to detect that a locking is given during a displacement movement of the saw blade 3 (in particular after the starting ramp of the first and/or second stepper motor) and as a response to this to immediately end the displacement movement, so that no deviation between the detected current saw blade position and the actual saw blade position occurs, and expediently (despite the occurrence of a locking) no calibration run is necessary.

Expediently, the saw device 10, in particular the control unit 14 is designed, given the calibration examination, to examine whether a voltage error, for example a previously effected voltage loss is given.

A voltage error is present for example if the supply voltage of the control unit 14 is temporarily too low or not present, e.g. because a battery of the saw device 10 has been removed or too little voltage is provided. A voltage error can lead to the calibration information, in particular the end position information, and/or the current first saw blade position value and/or the current second saw blade position value getting lost and/or becoming compromised.

The saw device 10 is preferably designed, as a response to the voltage error, to carry out the calibration run and/or output the calibration message.

Expediently, the saw device 10, in particular the control unit 14 is designed, given the calibration examination, to examine whether a detection of the current saw blade position is possible. In particular, the saw device 10, in particular the control unit 14 is designed, given the calibration examination, to examine whether the current first saw blade position value and/or the current second saw blade position value are present and/or are valid. As explained previously, the detection of the saw blade position in particular is effected incrementally, so that the current saw blade position values which were valid before a displacement movement of the saw blade 3 need to be present, in order after the displacement movement for these saw blade position values to be able to be used as the preceding saw blade position values, in order herewith to being able to compute the current saw blade position values which are valid after the displacement movement of the saw blade 3 (on the basis of the first and/or second rotor movement).

The saw device 10 is preferably designed, as a response to a detection of the current saw blade position not being possible, for example as a response to no current (or preceding) first saw blade position value and/or no current (or preceding) second saw blade position value being present, to carry out the calibration run and/or to output the calibration message.

Expediently, the saw device 10, in particular the control unit 14 is designed, given the calibration examination, to examine whether an operating time value which describes an operating time of the saw device, exceeds an operating time threshold value. The operating time threshold value for example defines a certain number of operating hours, after which a calibration run should be carried out.

The saw device 10 is preferably designed, as a response to the operating time value exceeding the operating time threshold value, to carry out the calibration run and/or to output the calibration message.

Optionally, the saw device 10 can be designed, as a response to switching on the saw device 10, to carry out the calibration examination and/or the calibration run.

Preferably, the saw device 10 is designed to only carry out the calibration run as long as a user input, in particular an actuation of an operating device 2 of the saw device 10 is present, and to stop the calibration run if the user input, in particular the actuation of the operating device 2 is no longer present. The user input for example is a pressing of one of the buttons 7 and/or a rotating and/or pressing of the rotary push button 6.

Optionally, the saw device 10 is designed, after a stopping of the calibration run, to continue the calibration run as a response to the user input, in particular the same user input being present again.

The control unit 14 is preferably designed, on the basis of the operating signal from the operating device 2, to examine whether the actuation of the operating device 2 is currently present, and to continue the calibration run (by way of a suitable control of the actuator device 11) for only as long as the actuation of the operating device 2 is currently present.

Preferably, the actuator device 11 is designed to adjust the saw blade position in two degrees of freedom—in particular the first degree of freedom 41 and/or the second degree of freedom 42. The saw device 10 in particular is designed, given the calibration run, to carry out a first calibration movement concerning which the saw blade 3 is moved in its first degree of freedom 41, and given the calibration run, to carry out a second calibration movement concerning which the saw blade 3 is moved in its second degree of freedom 42. The saw device 10 is expediently designed to carry out the first calibration movement and the second calibration movement at least partly simultaneously. In this manner, a short time duration of the calibration run can be achieved. For example, the complete calibration run lasts less than 40 seconds.

The saw device 10 is preferably designed, before the beginning of the calibration run, to store a current saw blade position—for example as a position memory information—and after the calibration run to bring the saw blade 3 into the stored saw blade position—thus into a saw blade position which corresponds to the stored position memory information. Advantageously, the saw device 10 moves the saw blade 3 back into the starting state (before the calibration run) for the completion of the calibration run.

Preferably, the actuator device 11 is designed to adjust the saw blade position in two degrees of freedom—in particular the first degree of freedom 41 and/or the second degree of freedom 42. The saw device 10 is preferably designed, given the calibration run, to move to one or both end positions of the one degree of freedom—for example the first degree of freedom 41—when the saw blade 3 is not situated in an end position of the other degree of freedom—for example, of the second degree of freedom 42. Preferably, the control unit 14 controls the actuator device 11 such that given the calibration run, the end positions of the first degree of freedom 41 are moved to when the saw blade 3 with respect to the second degree of freedom 42 is not at the lowest position—thus the end position with the minimal height. Expediently, the end positions of the first degree of freedom 41 are moved to when the saw blade with respect to the second degree of freedom 41 is situated above a height of 25 mm and/or 50% of the maximal height.

A purely exemplary design of the calibration run is to be explained hereinafter.

For example, the saw blade 3 is firstly pivoted about a first, in particular positive angle, in particular without an adjustment of the saw blade height. Expediently, the saw blade 3 is then moved up to a first (in particular lower) height end position and simultaneously up to a second (in particular positive) angle end position. The saw device 10 then sets the first current saw blade position value and the second current saw blade position value to the respective end position values (in particular determined by a first calibration) which correspond to the moved-to end positions. Expediently, the saw device then moves to the second (in particular upper) height end position and expediently in this second height end position carries out a plausibility examination of the saw blade height. In particular, given the plausibility examination, the saw device 10 examines whether the second saw blade position value which is detected on the basis of the second rotor movement corresponds to the second end position value with respect to the height. The saw device 10 then moves the saw blade 3 to a height below the second height end position and simultaneously moves the saw blade up to a first (in particular negative) angle end position. The saw device 10 in this first angle end position expediently carries out a plausibility examination of the saw blade angle.

In particular, given the plausibility examination, the saw device 10 examines whether the first saw blade position value which is detected on the basis of the first rotor movement corresponds to the second end position value with respect to the angle. The saw device 10 then brings the saw blade 3 into that saw blade position in which the saw blade 3 was positioned directly before carrying out the calibration run.

Expediently, the control unit 14 is designed, amid the use of the actuator device 11, to adjust the saw blade 3 in its saw blade position, so that the detected (on the basis of the first rotor movement) current first saw blade position value corresponds to a first position setpoint and/or the detected (on the basis of the second rotor movement) current second saw blade position value corresponds to a second position setpoint. Expediently, the first position setpoint and/or the second position setpoint can be inputted via the operating device 2, in particular via the rotary push button 6.

Preferably, the saw device 10 can be operated according to a method which comprises the step: detecting the current saw blade position on the basis of the first rotor movement.

Preferably, the method further comprises the step of carrying out a calibration run, in particular previously explained calibration run.

Optionally, a first calibration run, a starting operation calibration run and a height calibration run are carried out by the saw device 10. The first calibration run and/or the starting operation calibration run in particular are examples of the previously explained calibration run, so that the aforementioned explanations also apply to these calibration runs.

The first calibration run is expediently effected on the part of the factory, in particular directly after manufacture of the saw device 10 and/or before starting operation of the saw device 10 by a user. The starting operation calibration run and/or the height calibration run are expediently effected by the user, in particular on or after starting operation of the saw device 10 by the user.

With the first calibration run, the saw device 10 expediently determines the displacement region information and/or the end position information. Expediently, an angle zero position calibration concerning which the saw device 10 moves with the saw blade 3 to the first zero position (in particular on the basis of a stored first zero position value which describes the first zero position with regard to an end position value) is then effected. Expediently, the deviation of the saw blade 3 from the actual first zero position is subsequently measured, in particular by way of an external sensor unit, and the detected deviation is transferred to the control unit 14. The control unit 14 uses the deviation for the correction of the first zero position value and/or stores the deviation as the first offset value for the first zero position value.

With the starting operation calibration run, the saw device 10 moves to the end positions and/or zero positions of the saw blade 3, in particular in order to display to the user the course of the calibration run, and/or in order to compensate a possible mis-positioning of the saw blade position after manufacture (for example during a transport, e.g. due to vibrations), for example by way of a comparison of the detected current saw blade position and the actual saw blade position in an end position.

With the height calibration run, the saw device 10 moves the saw blade from below, in particular from a lower end position with respect to the saw blade height, upwards up to the upper edge of the saw blade at the height of the workpiece rest, and the saw blade is herewith situated in the second zero position. Optionally, this second zero position of the saw blade 3 can be automatically recognised by the saw device 10. Preferably, the saw device 10 via an actuation of the operating device 2 can be informed of the current saw blade position being the second zero position, so that the saw device 10 stores the current position as the second zero position, in particular with respect to an end position of the saw blade 3.

1-14. (canceled)

15. A saw device comprising a workpiece rest for the rest of a workpiece, a saw blade, as well as an electrical actuator device for setting a saw blade position of the saw blade relative to the workpiece rest, wherein the electrical actuator device comprises a first electrical actuator which comprises a first rotor and serves for setting the saw blade position in a first degree of freedom and the saw device is designed to detect a current saw blade position of the saw blade on the basis of a first rotor movement of the first rotor.

16. The saw device according to claim 15, wherein the saw device is designed to detect the current saw blade position without a position sensor on the basis of the first rotor movement.

17. The saw device according to claim 15, wherein the saw device is designed to detect a number of revolutions of the first rotor and/or a number of steps of the first rotor as the first rotor movement.

18. The saw device according to claim 15, wherein the electrical actuator device further comprises a second electrical actuator which serves for setting the saw blade position in a second degree of freedom and the saw device is designed to detect the current saw blade position on the basis of the first rotor movement and on the basis of a second rotor movement of a second rotor of the second electrical actuator.

19. The saw device according to claim 15, wherein the saw device is designed, amid the use of the actuator device, to carry out a calibration run of the saw blade, in order to obtain calibration information and/or in order to carry out a position comparison of the detected current saw blade position with an actual current saw blade position.

20. The saw device according to claim 19, wherein the calibration information comprises displacement region information which describes a displacement region of the saw blade between two end positions of the saw blade, and/or end position information which describes one or two end positions of the saw bade, and/or zero position information which describes one or two zero positions of the saw blade.

21. The saw device according to claim 19, wherein the saw device is designed to detect the saw blade position taking into account the calibration information.

22. The saw device according to claim 19, wherein the saw device is designed to examine, in the course of a calibration examination, whether the calibration run is necessary and, if the calibration examination results that the calibration run is necessary, to carry out the calibration run and/or to output a calibration message.

23. The saw device according to claim 22, wherein the saw device is designed to examine in the calibration examination:
whether a drive error is given and/or
whether a voltage error is given, and/or
whether a detection of the current saw blade position is possible, and/or
whether an operation time value which describes an operation time of the saw device exceeds an operation time threshold value.

24. The saw device according to claim 19, wherein the saw device is designed to carry out the calibration run for only so long as a user input is present, and to stop the calibration run when the user input is no longer present.

25. The saw device according to claim 19, wherein the actuator device is designed to set the saw blade position in two degrees of freedom and the saw device is designed, in the calibration run, to carry out a first calibration movement in which the saw blade is moved in its first degree of freedom, and in the calibration run, to carry out a second calibration movement in which the saw blade is moved in its second degree of freedom, and wherein the saw device is designed to carry out the first calibration movement and the second calibration movement at least partly simultaneously.

26. The saw device according to claim 19, wherein the saw device is designed to store, before the beginning of the calibration run, the current saw blade position and to bring, after the calibration run, the saw blade into the stored saw blade position.

27. The saw device according to claim 19, wherein the actuator device is designed to adjust the saw blade positions in two degrees of freedom, and the saw device is designed, in the calibration run, to only move to one or both end positions of the one degree of freedom when the saw blade is not situated in an end position of the other degree of freedom.

28. A method for operating a saw device according to claim 15, comprising the step: detecting the current saw blade position on the basis of the first rotor movement.

29. The saw device according to claim 15, wherein the saw device is a bench saw or mitre saw.

30. The saw device according to claim 15, wherein the first degree of freedom is a saw blade angle.

31. The saw device according to claim 18, wherein the second degree of freedom is a saw blade height.

32. The saw device according to claim 23, wherein the drive error comprises a locking and/or a slipping of the actuator device.

33. The saw device according to claim 23, wherein the voltage error comprises a previously effected voltage loss.

34. The saw device according to claim 24, wherein the user input is an actuation of an operating device of the saw device.
